(19) United States
(12) Patent Application Publication
(10) Pub. No.: US 2015/0001246 A1
(43) Pub. Date: Jan. 1, 2015

(54) OUTPUT STRUCTURE OF AUTOMATIC VENDING DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: CHIN-WEN YEH, New Taipei (TW); YANG XIAO, Wuhan (CN)

(21) Appl. No.: 14/313,706

(22) Filed: Jun. 24, 2014

(30) Foreign Application Priority Data
Jun. 28, 2013 (CN) 201310266075X

(51) Int. Cl. G07F 11/38

(52) U.S. Cl. CPC G07F 11/38
USPC 221/279

(57) ABSTRACT

An output structure of an automatic vending device includes an output box and a pushing device. The output box includes a box body. The box body includes a bottom panel and two side panels. The bottom panel includes a panel body. The panel body defines an output opening. The pushing device includes two racks mounted to the corresponding side panels, a pushing panel mounted between the two side panels, a connecting shaft secured to the pushing panel, and a two gears secured to the connecting shaft. The connecting shaft is slidably mounted between the two side panels. The gears engage with the corresponding racks. The gears are driven to rotate along the two racks to drive the pushing panel to push a product located between the two side panels to move toward the output opening.

### CROSS-REFERENCE TO RELATED APPLICATIONS

This application is related to co-pending U.S. Patent Application entitled “OUTPUT STRUCTURE OF AUTOMATIC VENDING DEVICE”, Attorney Docket No. US51399, US application number ______ filed on ______.

### FIELD

The present disclosure relates to vending devices, and particularly to an output structure of a vending device.

### BACKGROUND

Automatic vending devices allow customers to buy products twenty-four hours a day. When the customer purchases the product from the automatic vending device, a product can be fetched from an output structure of the vending device.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of an output structure of a vending device.

FIG. 2 is similar to FIG. 1, but viewed from another angle.

FIG. 3 is an assembled view of the output structure of FIG. 1.

FIG. 4 is a cross-sectional view of FIG. 3.

FIG. 5 is an assembled view of the output structure of FIG. 1, wherein one product is dropped out of the output structure.

FIG. 6 is similar to FIG. 4, but showing a rotating member in an open position and a product being dropped out of the output structure.

FIG. 7 is similar to FIG. 6, but showing the rotating member in a closed position and a product being pushed.

### DETAILED DESCRIPTION

The present vending output structure is illustrated by way of example and not by way of limitation in the figures of the accompanying drawings in which like reference numerals indicate similar elements. It should be noted that references to “an” or “one” embodiment in this disclosure are not necessarily to the same embodiment, and such references mean “at least one.”

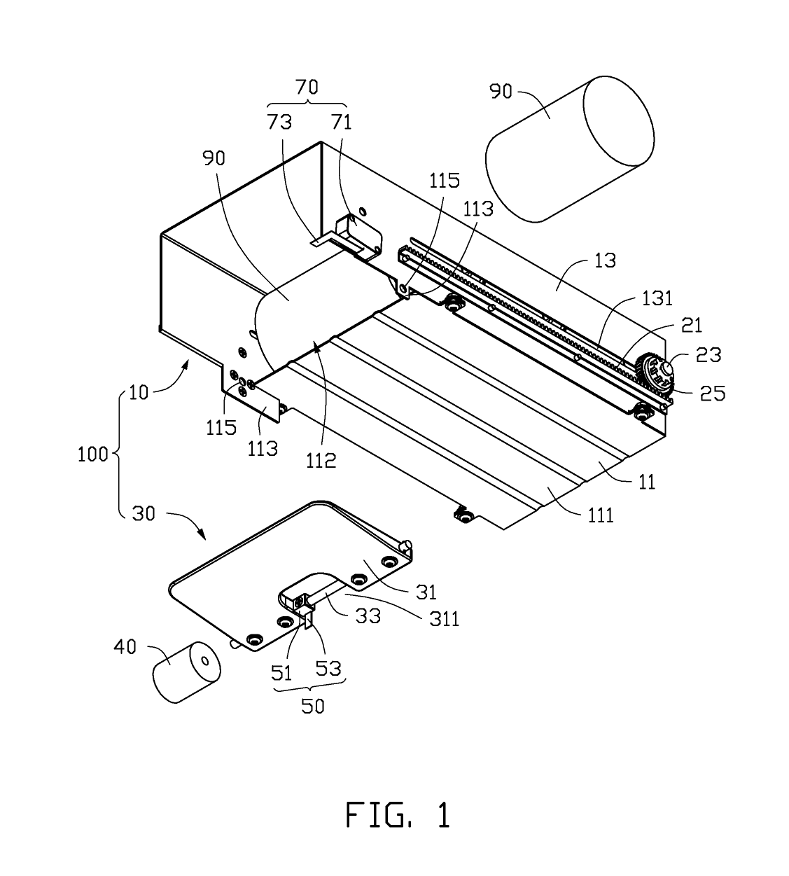

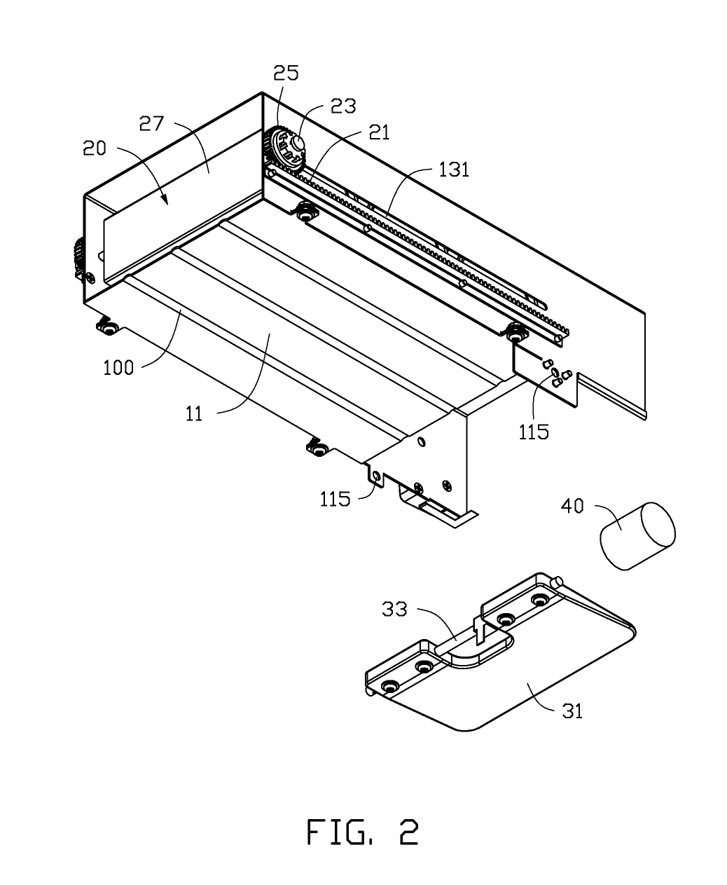

FIGS. 1 and 2 illustrate an embodiment of an output structure of a vending device. The output structure can include an output box 100, a pushing device 20, a drive device 40, a first sensor 50, and a second sensor 70.

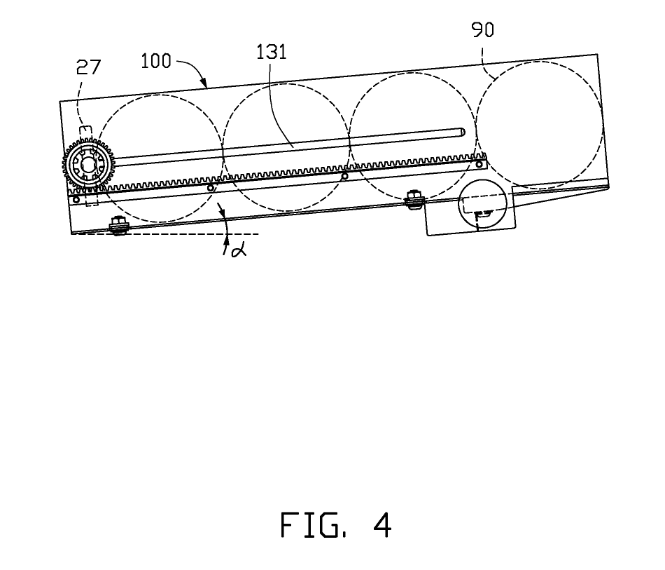

The output box 100 can include a box body 10 and a rotating member 30. The box body 10 can include a bottom panel 11 and two side panels 13. The bottom panel 11 can include a panel body 111 and two pivot tabs 113 extending from the panel body 111. The two pivot tabs 113 can be substantially perpendicular to the panel body 111. The panel body 111 can define an output opening 112. The two pivot tabs 113 can be located on opposite sides of the output opening 112. Each pivot tab 113 can define a pivot hole 115. Each side panel 13 can define a sliding slot 131. An extending direction of the sliding slot 131 can be substantially parallel to the panel body 111. An angle a can be defined between the panel body 111 and a horizontal plane (shown in FIG. 4).

The pushing device 20 can include two racks 21, a connecting shaft 23, two gears 25, and a pushing panel 27. The two gears 25 and the pushing panel 27 can be secured to the connecting shaft 23, and the pushing panel 27 can be located between the two gears 25. The two racks 21 can be mounted to corresponding outer sides of the two side panels 13. The connecting shaft 23 can extend through the two sliding slots 131 of the two side panels 13. The two gears 25 can engage with the corresponding racks 21. The pushing panel 27 can be located between the two side panels 13. The two racks 21 can be substantially parallel to each other and substantially parallel to the extending direction of the two sliding slots 131.

The rotating member 30 can include a rotating panel 31 and a pivot shaft 33 secured to the rotating panel 31. The rotating panel 31 can define a cutout 311. The pivot shaft 33 can be pivotably mounted in the pivot holes 115 of the pivot tabs 113. The drive device 40 can be secured to the pivot shaft 33 to drive the pivot shaft 33 to rotate. In one embodiment, the drive device 40 is a motor.

The first sensor 50 can include a first main body 51, and a first sensing end 53 extending from the first main body 51. The first main body 51 can be secured to the pivot shaft 33 and can rotate with the pivot shaft 33. The main body 51 can be received in the cutout 311.

The second sensor 70 can include a second main body 71, and a second sensing end 73 extending from the second main body 71. The second main body 71 can be secured to an outer side of one of the two side panels 13.

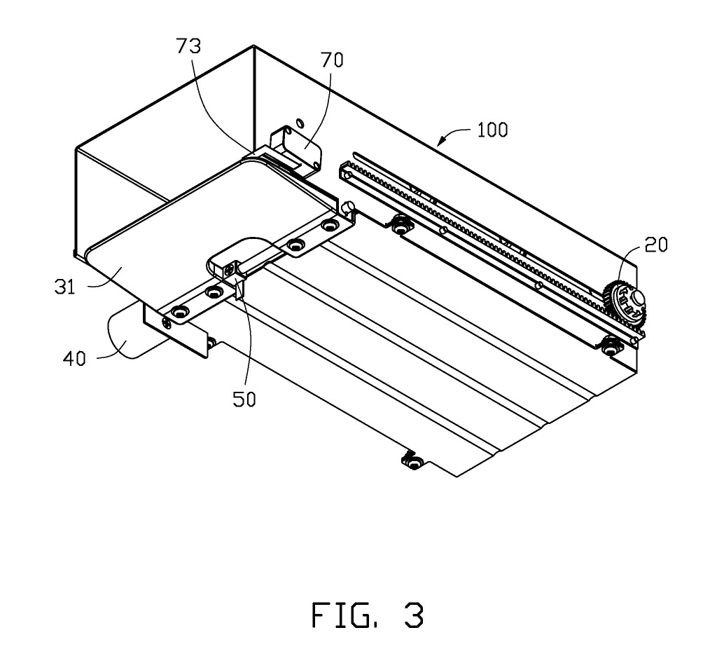

FIGS. 3 and 4 illustrate assembly of the output structure of the vending device. The pivot shaft 33 of the rotating member 30 can extend through the pivot holes 115 to pivotably mount the rotating member 30 to the box body 10. The drive device 40 can be secured to the pivot shaft 33. The rotating panel 31 of the rotating member 30 can cover the output opening 112. A plurality of products 90 can be received in the output box 100. One of the products 90 can be located above or on the rotating panel 31.

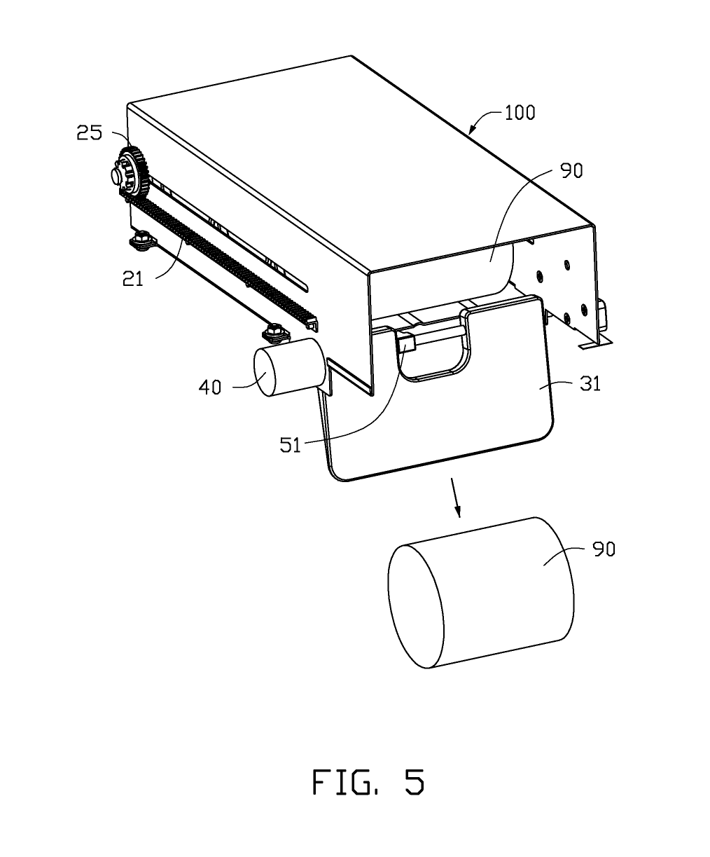

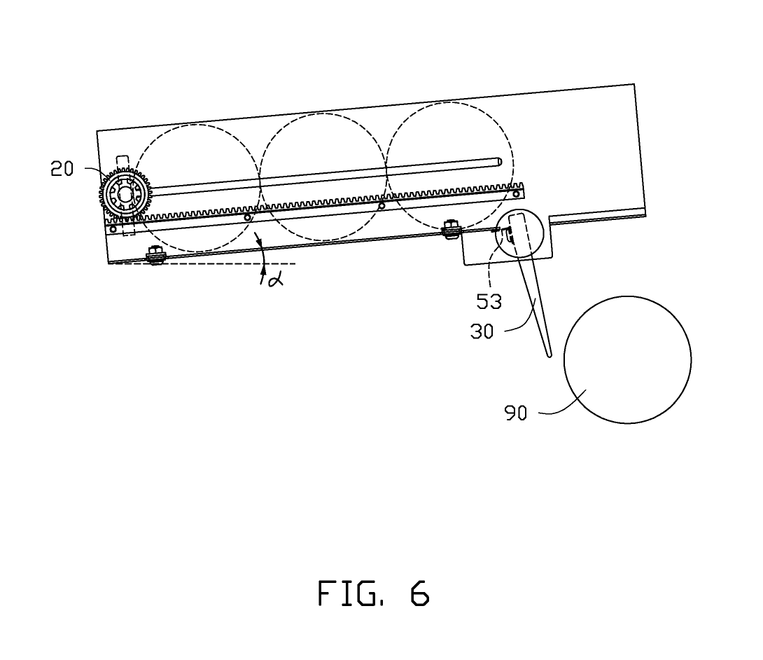

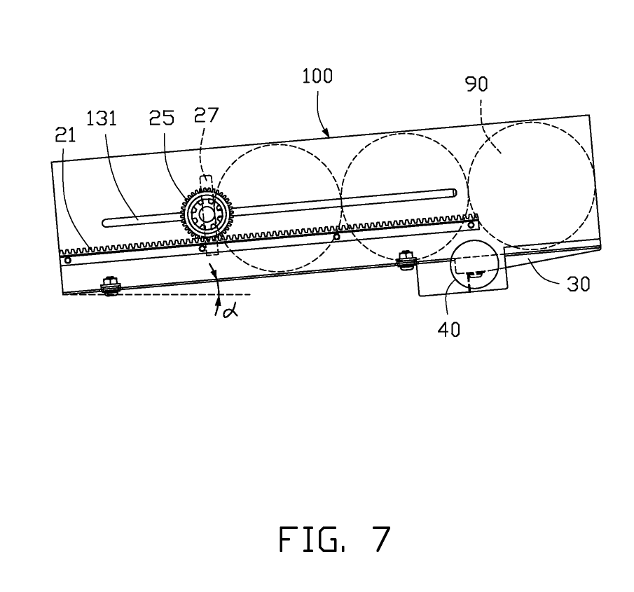

FIGS. 5-7 illustrate that the drive device 40 can rotate along a first rotation direction to drive the pivot shaft 33 to rotate, thereby enabling the rotating panel 31 to rotate to an open position. Thus, the output opening 112 can be exposed. The product 90 located above or on the rotating panel 31 can drop out of the output opening 112 due to gravity. The drive device 40 can stop rotating when the first sensing end 53 of the first sensor 50 contacts the panel body 111. Then, the drive device 40 can rotate along a second rotating direction opposite to the first rotation direction to enable the rotating panel 31 to rotate back to a closed position. The drive device 40 can stop rotating when the second sensing end 73 of the second sensor 70 contacts the rotating panel 31. The gears 25 of the pushing device 20, driven by another driving device (not shown), can rotate to drive the pushing panel 27 to move toward the rotating panel 31 to push another product 90 to move above or onto the rotating panel 31.

It is to be understood however that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An output structure of an automatic vending device comprising:
an output box, the output box comprising a box body; the box body comprising a bottom panel, a first side panel extending from the bottom panel, and a second side panel extending from the bottom panel; the bottom panel comprising a panel body; the panel body defining an output opening; and
a pushing device, the pushing device comprising a first rack mounted to the first side panel, a pushing panel mounted between the first side panel and the second side panel, a connecting shaft secured to the pushing panel, and a first gear secured to the connecting shaft; the connecting shaft slidably mounted between the first side panel and the second side panel; the first gear engaging with the first rack; an extending direction of the first rack being substantially parallel to the panel body; and the first gear is configured to be driven to rotate on the two racks to drive the pushing panel to push a product located between the first side panel and the second side panel to move toward the output opening.

2. The output structure of claim 1, wherein the first side panel defines a first sliding slot; the second side panel defines a second sliding slot; the connecting shaft is slidably mounted in the first sliding slot and the second sliding slot; an extending direction of the first sliding slot is substantially parallel to an extending direction of the second sliding slot and is substantially parallel to the extending direction of the first rack.

3. The output structure of claim 2, wherein the pushing device further comprises a second rack mounted to the second side panel and a second gear secured to the connecting shaft; the second gear engages with the second rack; and an extending direction of the second rack is substantially parallel to the extending direction of the first rack.

4. The output structure of claim 3, wherein the first gear is mounted to an outer side of the first side panel and the second gear is mounted to an outer side of the second side panel.

5. The output structure of claim 1, wherein the output box further comprises a rotating member pivotally mounted to the box body and a drive device secured to the rotating member; the rotating member is positioned in a first position to cover the output opening; the drive device is configured to drive the rotating member to rotate from the first position to a second position to expose the output opening.

6. The output structure of claim 5, wherein the bottom panel comprises two pivot tabs extending from the panel body; the output opening is defined in the panel body; each of the two pivot tabs defines a pivot hole; the rotating member comprises a rotating panel and a pivot shaft secured to the rotating panel; the pivot shaft is pivotably mounted in the two pivot holes; and the drive device is configured to drive the pivot shaft to rotate to drive the rotating panel to rotate.

7. The output structure of claim 6, wherein the two pivot tabs are substantially perpendicular to the panel body.

8. The output structure of claim 2, wherein there is an acute angle defined between the panel body and a gravity direction.

9. The output structure of claim 5, further comprising a first sensor secured to the rotating member; wherein the first sensor comprises a first main body and a first sensing end extending from the first main body; the first sensing end contacts the box body when the rotating member is located in the second position; and the drive device stops driving the rotating member when the first sensing end contacts the box body.

10. The output structure of claim 9, further comprising a second sensor; wherein the second sensor comprises a second main body and a second sensing end extending from the second main body; the drive device is further configured to drive the rotating member to rotate from the second position to the first position; the second sensing end is configured to contact the rotating member when the rotating member is located in the first position; the drive device is configured to stop driving the rotating member when the second sensing end contacts the rotating member.

11. An output structure of an automatic vending device comprising:
an output box, the output box comprising a box body; the box body comprising a bottom panel and two side panels extending from the bottom panel; and the bottom panel comprising a panel body; the panel body defining an output opening; and
a pushing device, the pushing device comprising two racks mounted to the two side panels, a pushing panel mounted between the two side panels, a connecting shaft secured to the pushing panel, and two gears secured to the connecting shaft; the connecting shaft slidably mounted between the two side panels; the two gears engaging with the two racks;
the two racks are substantially parallel to each other and substantially parallel to the panel body; and the two gears are configured to rotate on the two racks to drive the pushing panel to slide toward the output opening relative to the bottom panel.

12. The output structure of claim 11, wherein each of the two side panels defines a sliding slot; the connecting shaft is slidably mounted in the two sliding slots; extending directions of the two sliding slots are substantially parallel to each other and is substantially parallel to the extending direction of the rack.

13. The output structure of claim 12, wherein the two gears are mounted to outer sides of the two side panels.

14. The output structure of claim 11, wherein the output box further comprises a rotating member pivotally mounted to the box body and a drive device secured to the rotating member; the rotating member is positioned in a first position to cover the output opening; the drive device is configured to drive the rotating member to rotate from the first position to a second position to expose the output opening.

15. The output structure of claim 14, wherein the bottom panel comprises two pivot tabs extending from the panel body; the output opening is defined in the panel body; each of the two pivot tabs defines a pivot hole; the rotating member comprises a rotating panel and a pivot shaft secured to the rotating panel; the pivot shaft is pivotably mounted in the two pivot holes; and the drive device is configured to drive the pivot shaft to rotate to drive the rotating panel to rotate.

16. The output structure of claim 15, wherein the two pivot tabs are substantially perpendicular to the panel body.

17. The output structure of claim 12, wherein there is an acute angle defined between the panel body and a gravity direction.

18. The output structure of claim 14, further comprising a first sensor secured to the rotating member; wherein the first sensor comprises a first main body and a first sensing end extending from the first main body; the first sensing end contacts the box body when the rotating member is located in the second position; and the drive device stops driving the rotating member when the first sensing end contacts the box body.

19. The output structure of claim 18, further comprising a second sensor; wherein the second sensor comprises a second main body and a second sensing end extending from the second main body; the drive device is further configured to drive the rotating member to rotate from the second position to the first position; the second sensing end is configured to contact the rotating member when the rotating member is located in the first position; the drive device is configured to stop driving the rotating member when the second sensing end contacts the rotating member.
